(19) United States
(12) Patent Application Publication
(10) Pub. No.: US 2002/0111572 A1
(43) Pub. Date: Aug. 15, 2002

(54) Eight in one vibrating mattress pad

(76) Inventor: Abby Waters, Boca Raton, FL (US)

Correspondence Address: David W. Barman, 1101 NE 176 Terrace, North Miami Beach, FL, 33162, US

(21) Appl. No.: 10/045,602

(22) Filed: Oct. 23, 2001

Related U.S. Application Data
(60) Provisional application No. 60/242,226, filed on Oct. 23, 2000.

(51) Int. Cl. A61H 23/00

(52) U.S. Cl. 601/57; 601/46

(57) ABSTRACT

A vibrating mattress pad is disclosed and described.

### CROSS REFERENCE TO RELATED APPLICATIONS

This is a non-provisional patent application based on provisional application SNo. 60,242,226 filed on Oct. 23, 2000.

### BACKGROUND OF THE INVENTION

A typical person spends, on average, eight hours a day in bed. This time is to allow the body to recover spent energy and regain strength for the next period of waking hours.

There are many people that suffer from various muscular and neurological ailments. To these people, the time in bed only amounts to further discomfort.

There exist a virtual plethora of relaxation products commercially available. Many of these products are very expensive, or require a second person to help administer the relaxation therapy. The messaging chairs and recliners are very popular and also quite expensive. There is clearly a need for a commercial product that is easy to use for an individual, effective, and does not carry the large expense of many available products. Such a product would fill a tremendous need.

### SUMMARY OF THE INVENTION

It is an object of the current invention to provide an apparatus whereby the user can receive relaxation therapy. It is a further object of the invention to provide a product, which can provide message therapy to a person lying in a standard bed. It is another object of the invention to provide the therapy in the form of a vibrating mattress pad. It is another object of the invention that the vibrating mattress provides for placement of massage units in strategic locations to effectively provide the message therapy to the user.

It is yet another object of the invention to provide for the mattress pad to accommodate one or more users.

It is yet another object of the invention for each region of message to be controlled by one or more controllers.

### BREIF DESCRIPTION OF THE DRAWINGS

FIG. 1 shows a person lying down and illustrates the placement of various vibrating in the pad in relation to the lying person.

FIG. 2 shows the mattress pad with placement of vibrating motors.

### DETAILED DESCRIPTION OF THE PREFERRED EMBODIMENT

The current invention is a standard mattress pad comprising upper and lower portions. The mattress pads are secured permanently to each other with at least one opening where the electronic components can be placed. In allowing access to the electronic components, it allows them to be removed in order to clean or launder the mattress pad. Each corner has a fastening means by which the pad can be secured to the mattress. They can be elastic or any other suitable fastening means. In the side of the mattress pad, there is a hole which allows the electronic power and control wires to exit the mattress. This area can be secured in a closed position by a zipper, snaps, hook and eye fasteners or any suitable closing mechanism. The pad can be made to fit any standard mattress. Additionally, it can be made for two users as in the case with beds designed for more than one user. In the embodiment for two users, it can be designed with one or more variable electronic controllers. In a preferred embodiment, it can be made so each user has a separate variable electronic controller. The variable electronic controller can adjust the oscillatory movement of each of the vibrating electronic motors. The variable electronic controllers can eliminate the oscillatory motion of any of the individual vibrating electronic motors.

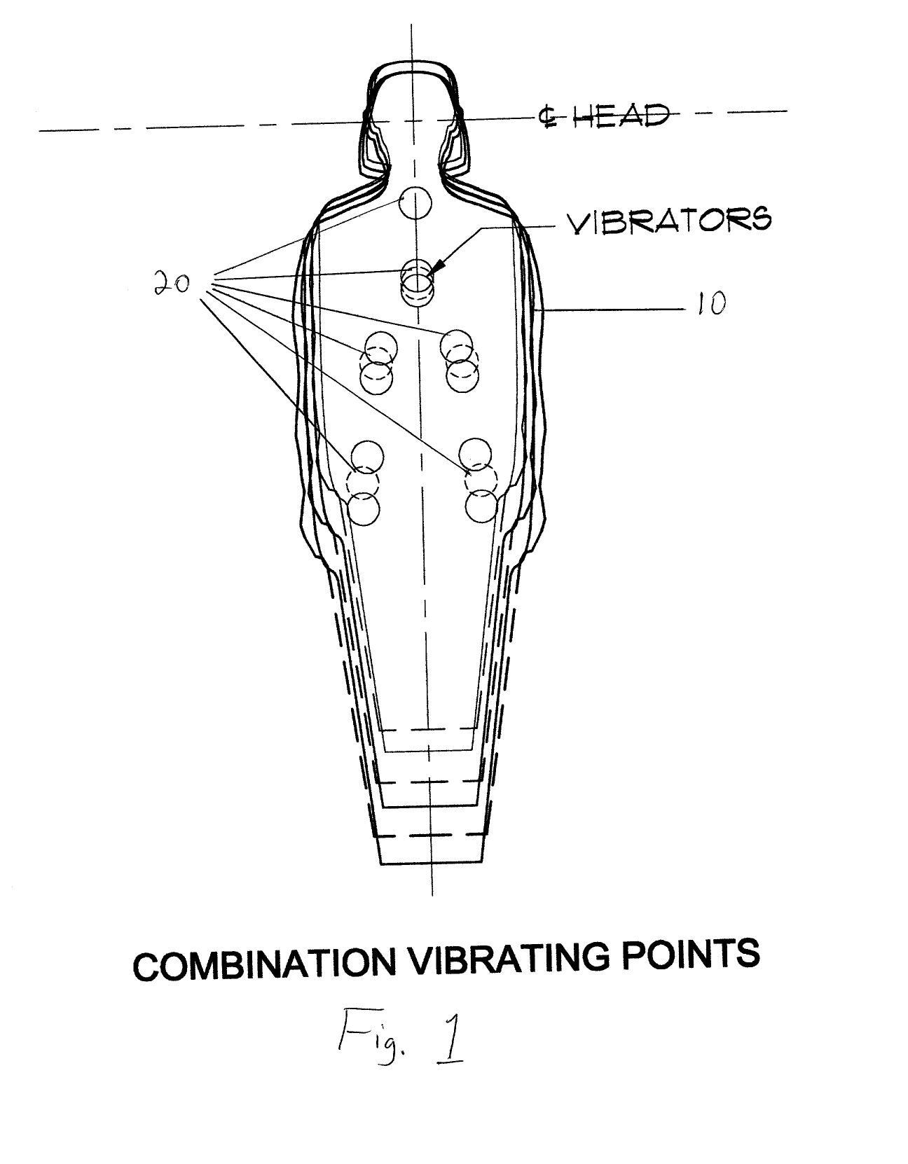

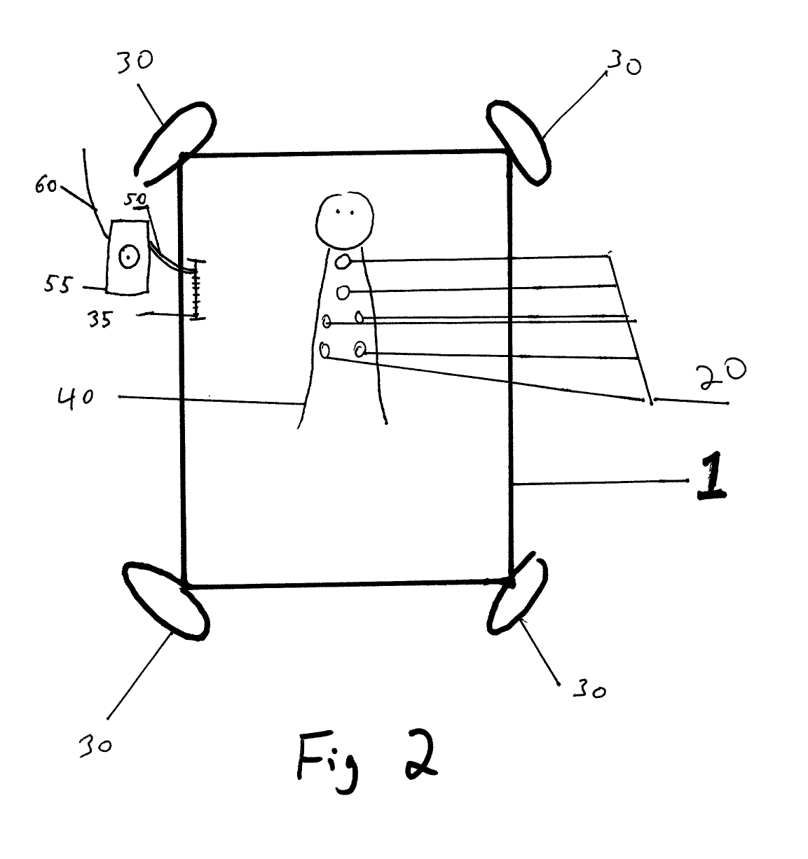

There are areas within the mattress pad in which each individual vibrating motor is to be placed. The motors are located at points including the head neck, shoulders and back. There can be additional placement of vibrating motors. as desired. FIG. 1. shows a person 10 lying on the mattress pad, and the placement of the vibrating motors 20 in relationship to the users body. FIG. 2 shows the mattress pad 1, with a printed region 40 that shows the user where to lie upon vibrating motors 20. Securing means 30 can be elastic or any other suitable means to secure the mattress pad to a mattress. There is a closing means 35, which closes the electronic components into the mattress pad. In one embodiment the closure means is a zipper. It can be any suitable means for closing an opening including, buttons, snaps, hook and eye fasteners. Electrical wires 50 carry power to the vibrating motors 20 and allow the motors to receive electronic adjustment signals from a controller 55. In a preferred embodiment, the user can be provided with a remoter which allows the user to individualize the motion of the vibrating motors. The remote can feature many different variable settings. A preferred embodiment provides for and eight feature remote control mechanism. The remote control mechanism comprises standard voltage, electrical transformation and variability as is commonly known in the art. The control unit receives its power from a supply cord 60, which is connected, to an external power source. The external power source can be a standard household current, a battery or a fuel cell.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A vibrating mattress pad comprising
a) vibrating motors
b) variable electronic controls
c) upper and lower mattress pad material with an inner region between said upper and lower pad material
d) securing means of mattress pad to a mattress

2. The vibrating mattress pad of claim 1 where the vibrating motors are placed to provide relaxation therapy.

3. The vibrating mattress pad of claim 1 where the vibrating motors are placed in a region to provide relaxation therapy to the head neck and back of the user.

4. The vibrating mattress pad of claim 1 where there is at least one variable electronic control.

5. The vibrating mattress pad of claim 1 where there are regions for at least one person to lay on the vibrating motors.

6. The vibrating mattress pad of claim 1 where there are two regions of vibrating motors for two people to lay on one bed.

7. The vibrating mattress pad of claim 1 where there is at lease one variable electronic controller for the vibrating electronic motors.

8. The vibrating mattress pad of claim 1 where each region of vibrating electronic motors are controlled by separate variable electronic controls.

9. The variable electronic controls of claim 1 wherein the controls can vary the oscillation speed of each vibrating electronic motor.

10. The variable electronic controls of claim 1 wherein the controls can eliminate the vibratory motion of any specific vibrating motor.

11. The vibrating mattress pad of claim 1 in which said upper and lower pads are secured to each other.

12. The securing means of claim one wherein said means is elastic straps.
